(19) United States
(12) Patent Application Publication
(10) Pub. No.: US 2017/0154549 A1
(43) Pub. Date: Jun. 1, 2017

(54) VERSATILE PIPE MARKER TAPE

(71) Applicants: Alexis Martial, Singapore (SG); You Tau Song, Kukup (MY); Yoong Gia Liang, Singapore (SG)

(72) Inventors: Alexis Martial, Singapore (SG); You Tau Song, Kukup (MY); Yoong Gia Liang, Singapore (SG)

(21) Appl. No.: 15/193,005

(22) Filed: Jun. 25, 2016

(30) Foreign Application Priority Data
Jun. 26, 2015 (SG) 10201505133Q

(51) Int. Cl. G09F 3/00; G09F 3/10

(52) U.S. Cl. CPC G09F 3/0295; G09F 3/10; G09F 2003/0229

(57) ABSTRACT

The pipe marker tape for marking predetermined set of pipes of at least two different outside circumferences comprises indicia on a front layer, an adhesive layer and a release liner with cut lines at a regular distance δ defining release liner stripes such that for each pipe of the predetermined set of pipes, there is a positive whole number K for which (K+1)×δ is equal to or greater than the sum of the outside circumference of said pipe and a predetermined overlap, so an individual wrap-around marker fitting installation on said pipe is obtained by cutting the pipe marker tape along two cut lines separated by K+1 release liner stripes, said cut lines left on the obtained markers defining at least three release liner stripes that facilitate installation.

### BACKGROUND OF THE INVENTION

1. Field of the Invention

The present invention is in the field of labelling of pipes, conduits, tubes and rods for their identification. More particularly the invention relates to a versatile pipe marker tape for identification of pipes and conduits in industrial and commercial installations.

2. Background Art

It is critically important, particularly in complex installations such as Oil & Gas, offshore, petrochemical, pharmaceutical, power generation and other industrial facilities that process hazardous fluids and gases, to clearly and easily identify the content, flow direction, origin, destination, pressure, operating temperature range, toxicity etc. of each and every of the many pipes present in such installations. The same apply to pipes in medical, healthcare, laboratory and R&D facilities, and to conduits for electrical and telecommunication wires in industrial and commercial applications.

To achieve the above, markers with indicia consisting of colors, text and graphic symbols are commonly applied to pipes so personnel can quickly and accurately identify their content.

Several standards of color coding, graphics, and text description for pipe markers indicia have been defined across industries and regions. These standards evolve over time to incorporate more stringent and specific rules based on historical experience, for example corrosion issues, recognized chemical toxicity, etc. At the time of this invention, such standards include, but are not limited to:

in the offshore industry ISO 14726:2008, ASME/ANSI A13.1-2007 and NORSOK standard L-004 Edition 2, September 2010;

for chemicals GHS Fifth revised edition;

for medical use NFPA99 and CGA C-9,

for ammonia refrigeration system IIAR bulletin #114,

for electric wire conduits usually ANSI A13.1-2007.

Similar standards apply to other industries or specific countries, and even in situations where no such standard is defined or mandatory, identifying pipe and conduits is a key element of the operation, maintenance and safety of facilities. It is also of interest that pipe characteristics such as outside diameter are normalized in reference tables such as ANSI Schedule 40 & 80, commonly called NPS (Nominal Pipe Size) or DN (Diametre Nominal).

Various proposals have been made to meet these requirements.

The traditional method involves painting the pipe with the appropriate color, text and graphics using dedicated stencil for each indicia or part of. With the increased complexity of targeted facilities and indicias, this approach has become inefficient: number of stencils and paint colors to be carried by installation team, difficulty in achieving consistent painting of indicia especially when the targeted pipe, or part of it, is hard to reach, etc. This approach is time and labor expensive and therefore not acceptable in most of the cases.

One common method in use at the present time is to adhere single indicia pipe markers printed beforehand to the exterior surface of targeted pipes. Such “single indicia self-adhesive pipe markers”, typically made of a polyvinyl chloride, commonly abbreviated PVC, film a.k.a. vinyl, consist of a layer printed with the marker indicia and a self-adhesive layer with a peel-off liner. Though these pipe markers are economical, insuring the adhesive tape sticks to the pipe surface can be problematic when dirty, greasy, or difficult to adhere to, for example in the case of the presence of insulation jacket. U.S. Pat. No. 6,183,016 describes a labeling tape designed to address specifically and only this latest problem.

In addition such pipe markers provide only a limited line of sight and thus typically must be installed in multiple positions, compounding the problem and increasing labor cost.

One attempt to overcome the problems listed in the above paragraph are so-called “self-adhesive wrap-around pipe markers” consisting of a similar self-adhesive pipe marker printed with repeated indicia parallel to markers width and of a length allowing them to be installed so as to fully cover the perimeter of the targeted pipes with extra length used to overlap and adhere the marker to itself to self-secure it to the pipe. These self-adhesive wrap-around pipe markers come either as individual pieces or in form of tape or roll that must be cut to the correct length prior to installation. U.S. Pat. No. 4,430,816 proposes a method to have a generic marker tape and to use pre-printed “windows” to cater to different indicia. It should also be noted that at least standard ISO 14726:2008 allows, for pipes of diameter greater than 200 mm, the use of so-called “half-wrap” self-adhesive pipe markers that cover about half of the circumference of the pipe to reduce cost and simplify installation since it is difficult for one installer to wrap-around a marker around such pipe.

However, self-adhesive pipe markers described above, either single indicia or wrap-around or half-wrap, cannot be used in various contexts of growing importance where adhesive and/or halogen-containing materials (ex: PVC), are not authorized to be in contact with the pipe material, for example due to corrosion issues or to facilitate marker removal or replacement during maintenance.

In such situation, of increase adoption are “non-adhesive wrap-around pipe markers”, made of a thin non-adhesive printed plastic film, generally polyethylene terephthalate a.k.a. P.E.T. aka polyester to satisfy temperature and dimensional stability requirements, such pipe marker including an extra stripe, typically around one inch (25 mm), of adhesive tape at one or both ends, half of its width being pre-bonded to the marker and the other half with a release liner so it can be used to self-secure the marker to itself around the pipe. One significant disadvantage of such pipe markers is that they cannot be used when a fully adhesive marker is either mandatory or preferred by the user. Another significant disadvantage of such markers, due to the peculiarity of the added stripe of tape and related manufacturing process, is that they come only as individual pieces matching either a specific pipe diameter or a pipe diameter range with the marker length defined to match the highest diameter in the range, thus wasting material and potentially requiring extra cutting process during installation. Other disadvantages are consequences of the use of this small stripe of added tape to secure such pipe marker to itself: limited adhesion strength and aging resistance, easily damaged release liner resulting in unusable pipe marker, and potential non-compliance to standard required overlap width, for example when defined as a ratio of pipe diameter as in NORSOK standard L-004.

The above drawbacks, weaknesses and limitations of self-adhesive and non-adhesive pipe markers described above complicate procurement and storage, increase waste and costs and thus do not satisfy their users.

Other pipe identification systems include plastic plates with or without brackets mounted with wrapping straps, for example in U.S. Pat. No. 4,246,712, or clipping system for example in U.S. Pat. No. 5,311,688, and so-called “snap-on” semi-rigid clip-on markers, described for example in DE 10 2008 014 937 A1. These systems, each with their own advantages and disadvantages, example size specific to pipe diameter, incur very high costs compared to the pipe markers described previously.

In the wider field of labelling, various techniques are either in common use or have been proposed to allow easy separation of individual labels from a label tape by using pre-perforated lines or so called “kiss-cut” that only extent to the front layers. These techniques are used for example for the manufacturing of one-use security luggage tags used in the aviation industry. In the field of stationery stickers and labels such techniques are sometimes combine to facilitate the use of blank printable labels. In the field of inkjet printing, U.S. Pat. No. 6,716,492 proposed a specific way of producing half-cut lines on blank printable media to allow stable conveying during printing of such media.

However none of the proposals described in the prior paragraph can be directly applied to the problems of pipe markers detailed above and thus no prior art or proposals have fully addressed the problem of pipe identification. By their very nature, they are costly or leading to waste and procurement complexities, and are not versatile enough to support in an efficient manner the requirements and constraints of typical industrial pipe marking projects.

Made in view of the above, the present invention has for its object a versatile pipe marker tape which can solve the above-described problems involved in the prior art of pipe markers/identification.

### SUMMARY OF THE INVENTION

It is a principal object of the present invention to provide a pipe marker tape with pipe indicia printed on a front layer, an adhesive layer and a release liner, this release liner having cut lines at specific intervals that firstly provide a guide to cut the tape into individual wrap-around pipe markers fitting various pipe diameters and secondly enable these pipe markers versatile installation in multiple non-adhesive and adhesive modes by selective removal or conservation of parts or all of their release liner.

It is contemplated that the present marker tape may benefit from having its release liner, printed layer and protective layer if present, be of the same material chosen to be compatible with the mechanical, chemical and other requirements that apply to the marker installation, such material preferably being polyester film.

Among the many different possibilities contemplated, the release liner cut lines may advantageously consist of discontinuous cuts whose lengths and intervals facilitate the manual removal of parts or in full of the release liner of obtained pipe markers simply by adjusting the removal effort direction.

It is also contemplated that the release liner may benefit from having labels with text and symbols indicating each cut lines position and interval to ease their selection to obtain a chosen set of wrap-around pipe markers.

It is further proposed that printed indicia location and length may match underlying release liner cut lines so that in addition of being able to obtain wrap-around pipe markers as described above, it may be possible to get single indicia self-adhesive pipe markers by cutting along two consecutive cut lines, and half-wrap self-adhesive pipe markers by cutting along two selectively chosen cut lines.

An additional object of the present invention is a pipe marker tape that, when the exact quantity of each pipe marker dimension is known in advance, the cut lines that separate each marker, and only those lines, may advantageously be perforated through all the tape layers to allow the manual separation of each individual marker without requiring cutting tools.

Finally, it is contemplated that the pipe marker tape object of the present invention, when containing series of different pipe marker indicia, may benefit from any of these series being preceded by printed description on the front layer of the serie's characteristics, such as length and targeted system, and optionally with a summary of the full roll content printed at the beginning of the roll itself, these printed portions being advantageously delineated by lines perforated through all the tape layers for easier separation.

Various objects, features, aspects, and advantages of the present invention will become more apparent from the following detailed description of preferred embodiments of the invention, along with the accompanying drawings.

### BRIEF DESCRIPTION OF THE DRAWINGS

FIG. 1 is a perspective view of the back side of a preferred embodiment of pipe marker tape according to the present invention illustrating individual pipe markers obtained from said tape.

FIG. 2 is a sectional view along a portion A-A of pipe marker tape of FIG. 1 illustrating a preferred embodiment of said pipe marker tape layers and release liner cut lines.

FIG. 3 is a perspective view of the front of an obtained individual pipe marker of FIG. 1 illustrating typical imprint of marker information and positions of another preferred embodiment of release liner cut lines.

FIG. 4 is a sectional view of pipe marker of FIG. 3 along B-B, one of its cut lines, illustrating said preferred embodiment of release liner cut lines.

FIG. 5 is a perspective view of the back of the marker of FIG. 3 illustrating partial removal of said marker release liner.

FIG. 6 is a perspective view of the back of the marker of FIG. 3 illustrating removal of all of said marker release liner

FIG. 7 is a perspective view of a marker shown in FIGS. 1 to 4 after installation on a pipe.

FIG. 8 is a sectional view of a marker shown in FIG. 3 illustrating the removal of one outer stripe of said marker release liner during installation in non-adhesive wrap around mode.

FIG. 9 is a sectional view of the marker shown in FIG. 8 after installation in overlap mode.

FIG. 10 is a sectional view of the marker shown in FIG. 3 illustrating the removal of the two outer stripes of said marker release liner during installation in secure mode.

FIG. 11 is a sectional view of the marker shown in FIG. 10 after installation in said secure mode.

FIG. 12 is a sectional view of the marker shown in FIG. 3 illustrating the removal in full of the release liner of said marker during installation in self-adhesive wrap-around mode.

FIG. 13 is a sectional view of the marker shown in FIG. 12 after installation in self-adhesive wrap-around mode.

FIG. 14 is a sectional view of the marker shown in FIG. 3 illustrating the removal of a central stripe of the release liner of said marker during installation in a variation of the self-adhesive wrap-around mode.

FIG. 15 is a sectional view of the marker shown in FIG. 14 at a later stage of installation in a variation of the self-adhesive wrap-around mode.

FIG. 16 is a perspective view of the back side of another preferred embodiment of pipe marker tape according to the present invention.

FIG. 17 is a perspective view of the front side of the pipe marker tape of FIG. 16 illustrating its various parts.

FIG. 18 is a detailed view of the labelling of release liner cut lines of FIG. 16-17.

FIG. 19 is a detailed view of the labelling of cut-through lines of FIG. 16-17.

### DETAILED DESCRIPTION OF PREFERRED EMBODIMENTS

For the purpose of this description and claims: “pipe” means pipe, conduit, tube or other generally cylindrically shaped hollow construction, either rigid or flexible, for conveying a substance, electric wirings or fiber optics from one point to another; “indicia” means texts, graphics and/or color(s) related to the “pipe” content, flow direction or any other information that seems fit for the purpose of identifying, operating or maintaining the pipe; “marker” or “pipe marker” or “individual pipe marker” means label or marker or film that include an indicia and that can be installed on a targeted “pipe”; “wrap-around pipe marker” or “wrap-around marker” means a “marker” that can fully cover the perimeter of the targeted pipe with extra length used to overlap and secure it; “marker tape” or “pipe marker tape” means roll or tape of one or multiple “markers”; “easily” means manually and without the need for extra tools or equipment nor special precautions.

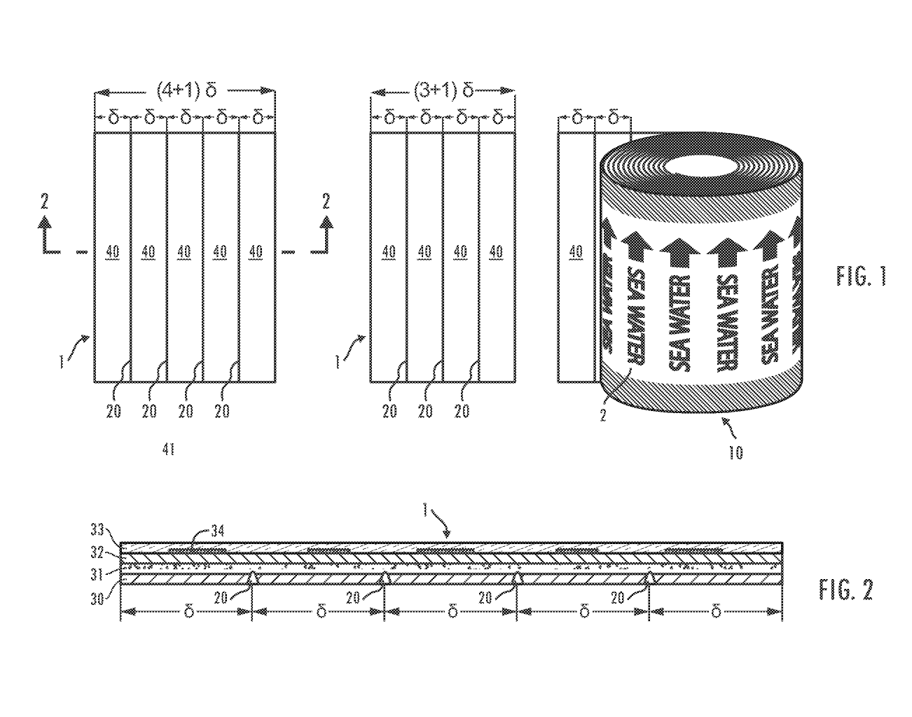

A preferred embodiment of a pipe marker tape 20 in accordance with the present invention is illustrated in FIGS. 1 and 2.

As shown in FIGS. 1 and 2, pipe marker tape 20 comprises a release liner 30 having cut lines 23 along the width ω of marker tape 20 thus parallel to the pipe axis to which the pipe marker is to be installed, an adhesive layer 31 preferably permanent pressure-sensitive, a layer suitable for print 32 preferably white, an imprint 33 that constitutes with the color of 31 as background the marker indicia 22 and optionally a transparent protective layer 34.

The liner 30 and the layers 32 and 34, when present, are typically made of plastic film, preferably polyester (also called BoPET or PET), due to its dimensional stability and chemical resistance, each of these layers having a typical thickness ranging from 10 μm to 100 μm. The imprint 33 is preferably made of solvent inks when layer 34 is present and made of UV-cured inks for improved weather resistance when layer 34 is absent. The material of each one of liner 30 and the layers 32 and 34 is independently chosen to conform to the normative and environmental conditions in which the marker 21 is to be used (example: operating temperature range, chemical exposure, no halogen allowed, etc.), with special attention for the material of release liner 30 that according to the present invention will at least partially be conserved and stay in place in some of the installation modes detailed thereafter.

As illustrated in FIG. 2, lines 23 cut through release liner 30 only. For practical considerations, due to liner 30 thickness tolerance and the limited accuracy of equipment to be used to cut such lines 23, it is acceptable for 23 to partially penetrate layer 31 as can be seen in FIG. 2, as long as layer 32 is left intact.

As emphasized in FIG. 1, lines 23 are regularly spaced over pipe marker tape 20 at a distance δ, with two successive lines 23 defining one stripe 40.

### First Example of Determination of δ

This distance δ is determined for a given set of pipe sizes and minimum overlap requirements according to the present invention as detailed in the next paragraph such that, by repeatedly cutting along two non-contiguous lines 23, it is obtained individual wrap-around pipe markers 21, each of those markers having a length sufficient to be equal to or greater than the sum of the outside circumference of said pipe and the required overlap, with any one of the two outer stripes 40 of said marker sufficient to represent the required overlap and the other contiguous stripes sufficient to represent the perimeter of the targeted pipe.

For standard cylindrical pipes, nominal pipe size, aka its diameter, being multiple of ¼″, a said given set of pipe sizes will have a Greatest Common Divisor G itself multiple of ¼″, and a distance δ minimizing the number of stripes is in first approximation equal to G multiplied by TT.

However actual pipe outside diameters for small and medium sizes are significantly greater, and in non-proportional manner, than the stated nominal sizes, and must be considered together with overlap requirements to determine an optimum distance δ that firstly allow matching the given set of sizes and overlaps, and secondly minimize any extraneous length result of the operation.

### Second Example of Determination of δ

According to a preferred embodiment of the present invention, given nominal pipe sizes {N₁, N₂, . . . } and respective overlaps {O₁, O₂, . . . }, it is in a first step determined actual pipe perimeters {P₁, P₂, . . . }, G=Greatest Common Divisor of {N₁, N₂, . . . }, and {K₁, K₂, . . . } where Kₗ=Nₗ÷G, than in a second step distance δ is found using a linear programming method, for example the Simplex algorithm of Dantzig, to minimize ΣWₗ subject to each Wₗ>=0 with Wₗ=Lₗ−(Pₗ+Oₗ) and Lₗ=(Kₗ+1)× δ, Lₗ representing the length of marker l consisting of (K+1) stripes and Wₗ representing the extraneous length of marker l if any. Three examples of distance S found using said method for three different sets of pipe sizes compliant with ANSI SCHEDULE 40 and different overlap requirements are presented in the tables below for reference:

TABLE 1
Pipe nominal sizes of 4″, 6″ and 8″ - Overlap Requirement 10% of P

| | | | | | | | Obtained Markers | | | |
|---|---|---|---|---|---|---|---|---|---|---|
| Given | | O | | | | | | Actual | | |
| Set of | Actual | Overlap | P | G | | | L | Overlap | W | W |
| Sizes | OD [″] | [mm] | [mm] | (GCD) | K | δ | [mm] | [mm] | [mm] | [%] |
| 4″ | 4.50″ | 35.9 | 359.1 | 2″ | 2 | 151.4 mm | 454.2 | 95.1 | 59.2 | 15.0% |
| 6″ | 6.63″ | 52.9 | 528.7 | | 3 | | 605.6 | 76.9 | 24.1 | 4.1% |
| 8″ | 8.63″ | 68.8 | 688.2 | | 4 | | 757.0 | 68.8 | 0.0 | 0.0% |

| | |
|---|---|
| To Minimize, ΣW: 145.8 | 4.0% |

TABLE 2
All Sizes from 3″ to 10″ - Overlap Requirement fixed at 25.0 mm

| | | | | | | | Obtained Markers | | | |
|---|---|---|---|---|---|---|---|---|---|---|
| Given | | O | | | | | | Actual | | |
| Set of | Actual | Overlap | P | G | | | L | Overlap | W | W |
| Sizes | OD[″] | [mm] | [mm] | (GCD) | K | δ | [mm] | [mm] | [mm] | [%] |
| 3″ | 3.50 | 25.0 | 279.3 | ½″ | 6 | 43.5 mm | 304.5 | 25.2 | 0.2 | 0.1% |
| 3½″ | 4.00 | 25.0 | 319.2 | | 7 | | 348.0 | 28.8 | 3.8 | 1.1% |
| 4″ | 4.50 | 25.0 | 359.1 | | 8 | | 391.5 | 32.4 | 7.4 | 1.9% |
| 4½″ | 5.00 | 25.0 | 399.0 | | 9 | | 435.0 | 36.0 | 11.0 | 2.6% |
| 5″ | 5.56 | 25.0 | 443.9 | | 10 | | 478.5 | 34.6 | 9.6 | 2.0% |
| 6″ | 6.63 | 25.0 | 528.7 | | 12 | | 565.5 | 36.8 | 11.8 | 2.1% |
| 7″ | 7.63 | 25.0 | 608.4 | | 14 | | 652.5 | 44.1 | 19.1 | 3.0% |
| 8″ | 8.63 | 25.0 | 688.2 | | 16 | | 739.5 | 51.3 | 26.3 | 3.7% |
| 9″ | 9.63 | 25.0 | 768.0 | | 18 | | 826.5 | 58.5 | 33.5 | 4.2% |
| 10″ | 10.75 | 25.0 | 857.8 | | 20 | | 913.5 | 55.7 | 30.7 | 3.5% |

| | | |
|---|---|---|
| To Minimize, ΣW: | 153.4 | 2.4% |

TABLE 3
Most Sizes from 3″ to 10″ - Overlap
Requirement 5% of P and at least 20.0 mm

| | | | | | | | Obtained Markers | | | |
|---|---|---|---|---|---|---|---|---|---|---|
| Given | | O | | | | | | Actual | | |
| Set of | Actual | Overlap | P | G | | | L | Overlap | W | W |
| Sizes | OD[″] | [mm] | [mm] | (GCD) | K | δ | [mm] | [mm] | [mm] | [%] |
| 3″ | 3.50″ | 20.0 | 279.3 | 1″ | 3 | 81.9 mm | 327.6 | 48.3 | 28.3 | 9.5% |
| 4″ | 4.50″ | 20.0 | 359.1 | | 4 | | 409.5 | 50.4 | 30.4 | 8.0% |
| 5″ | 5.56″ | 22.2 | 443.9 | | 5 | | 491.4 | 47.5 | 25.3 | 5.4% |
| 6″ | 6.63″ | 26.4 | 528.7 | | 6 | | 573.3 | 44.6 | 18.2 | 3.3% |
| 7″ | 7.63″ | 30.4 | 608.4 | | 7 | | 655.2 | 46.8 | 16.3 | 2.6% |
| 8″ | 8.63″ | 34.4 | 688.2 | | 8 | | 737.1 | 48.9 | 14.4 | 2.0% |
| 9″ | 9.63″ | 38.4 | 768.0 | | 9 | | 819.0 | 51.0 | 12.6 | 1.6% |
| 10″ | 10.75″ | 42.9 | 857.8 | | 10 | | 900.9 | 43.1 | 0.2 | 0.0% |

| | | |
|---|---|---|
| To Minimize, ΣW: | 145.8 | 4.0% |

If now considering FIG. 1 as a pipe marker tape build using distance δ of Table 3 above, it is immediately evident that the two pipe markers obtained and shown in said FIG. 1 are respectively for a pipe diameter of four inches (left marker) and a pipe diameter of three inches (marker shown at the center of FIG. 1).

### Third Example of Determination of δ

In the general case of unconstrained pipe outside perimeters {P₁, P₂, . . . } and related overlaps {O₁, O₂, . . . }, a preferred embodiment of the present invention is for distance δ and related {K₁, K₂, . . . } to be determined by solving the constraints: Minimize the weighted sum of ΣKₗ and ΣWₗ with each Wₗ>=0. Using a weight of 5 for ΣKₗ and a weight of 1 ΣWₗ, and a search heuristic commonly called evolutionary algorithm commercially available, for example as a solver Add-In in Microsoft Excel software, has proven to provide reliable results, as demonstrated in the table below where said method was used on {P₁, P₂, . . . } and {O₁, O₂, . . . } taken from table 2 above so as to confirm the validity of this method:

TABLE 4
Results of method for unconstrained parameters when those
match Table 3

| | | | | Obtained Markers | | | |
|---|---|---|---|---|---|---|---|
| O | | | | | Actual | W | |
| Overlap | P | | | L | Overlap | (Extra) | W |
| [mm] | [mm] | K | δ | [mm] | [mm] | [mm] | [%] |
| 20.0 | 279.3 | 3 | 81.9 mm | 327.6 | 48.3 | 28.3 | 8.6% |
| 20.0 | 359.1 | 4 | | 409.5 | 50.4 | 30.4 | 7.4% |
| 22.2 | 443.9 | 5 | | 491.4 | 47.5 | 25.3 | 5.2% |
| 26.4 | 528.7 | 6 | | 573.3 | 44.7 | 18.2 | 3.2% |
| 30.4 | 608.4 | 7 | | 655.2 | 46.8 | 16.3 | 2.5% |
| 34.4 | 688.2 | 8 | | 737.1 | 48.9 | 14.5 | 2.0% |
| 38.4 | 768.0 | 9 | | 819.0 | 51.0 | 12.6 | 1.5% |
| 42.9 | 857.8 | 10 | | 900.9 | 43.1 | 0.2 | 0.0% |

| | | | | |
|---|---|---|---|---|
| ΣK: | 52 | ΣW: | 145.9 | 3.8% |

| | |
|---|---|
| To Minimize, weighted 5ΣW + 1ΣK: | 405.9 |

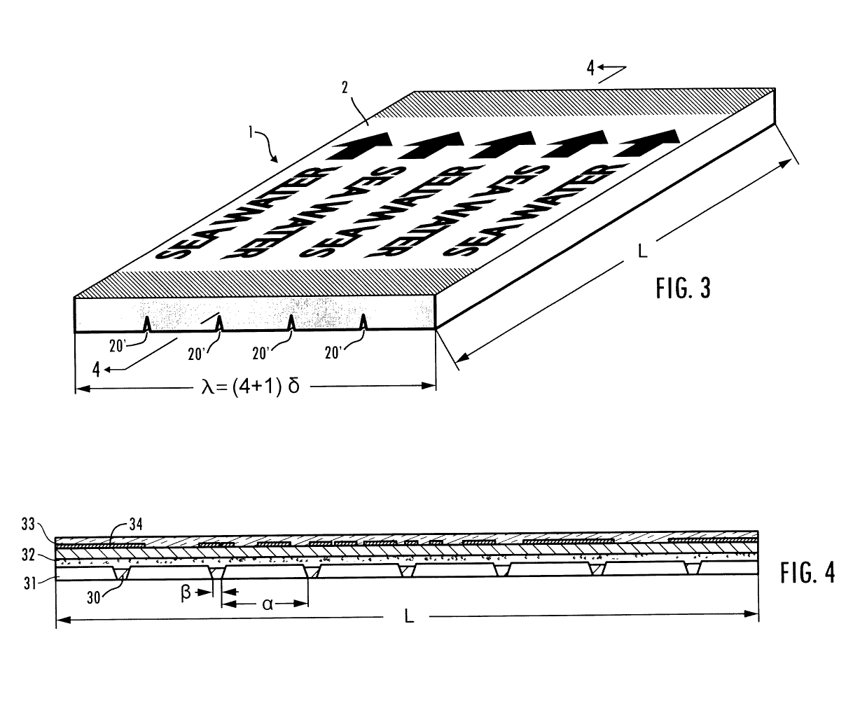

While FIG. 3 and subsequent, for simplification, show an obtained pipe marker 21 with four of such lines 23, it is to be noted that the actual number of such lines 23 present on any obtained pipe marker could range from one to more than ten depending on the targeted pipe outside diameter to be matched by each pipe marker as demonstrated above.

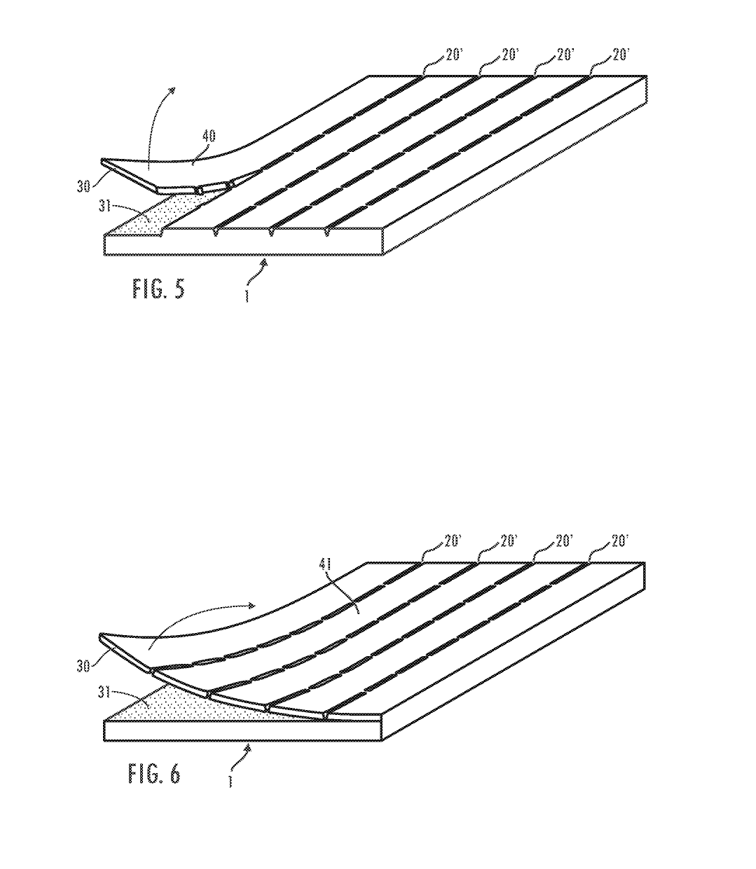

As illustrated in FIG. 4, a preferred embodiment of cut lines 23 are for these to be made of discontinuous cuts, with cut portions length α significantly longer than uncut portions length β, and the start and end of lines 23 also being cut portions, preferably symmetric as to match the entire marker width ω, such lines 23 defining stripes 40 parts of the release liner 41 of pipe marker 21. The lengths α and β are defined such that they allow a user to easily either remove one stripe 40 as illustrated in FIG. 5 by applying effort longitudinally along 40 or to remove all the release liner 41 as illustrated in FIG. 6 by applying effort near perpendicularly to 40 or across 41. It should be noted that it is also possible to easily remove multiple contiguous stripes 40 anywhere in the release liner 41 by starting the removal process longitudinally along the first selected stripe 40 and switching to orthogonal direction when required.

As a reference, with layer 30 being made of 25 μm(±2 μm) polyester, layer 31 made of 21 μm(±2 μm) pressure sensitive permanent acrylic adhesive, cut lines 23 having a repeated pattern of length α in a range of 5 mm to 30 mm and length β in a range of 0.4 mm to 0.7 mm made using an off-the shelves vinyl cutter with a 45° blade, 180 g pressure and a blade depth of approximately 30 μm, provide satisfactory results for the differentiated removal shown in FIGS. 5 and 6. Different cut and uncut lengths for discontinuously cut lines 23 would have to be determined for different materials and thicknesses and specificities of the manufacturing equipment used for production of said discontinuously cut lines 23, a good starting point being to refer to the established practices for producing standard perforated lines on the material and thickness chosen for release liner 30.

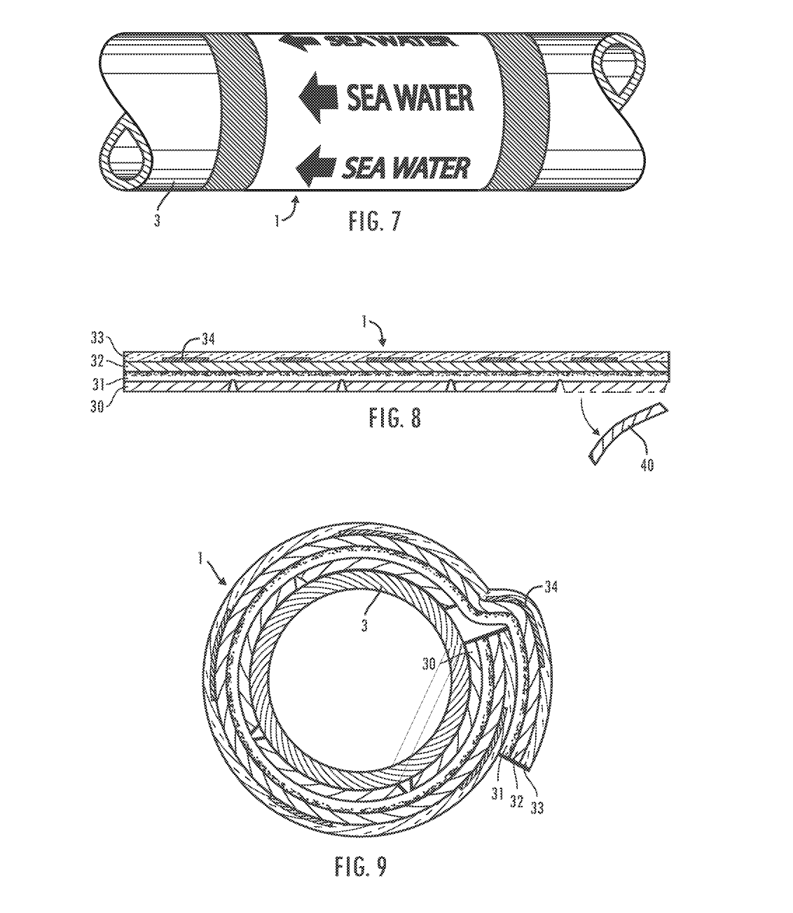

It is one of the important objects of this invention that the installation of wrap-around pipe marker 21 on pipe 25 as shown in FIG. 7 can be easily accomplished in multiple ways as illustrated in FIGS. 8 to 15 to match the installation technical, normative requirements, practical conditions (difficulty of access, etc.) and user preferences as a result of the characteristics and position of the cut lines 23 present on the liner 30 of marker 21.

FIG. 8 illustrates the removal of one outer stripe 40 using method shown in FIG. 5 during installation in non-adhesive wrap around mode. This method consists of wrapping marker 21 around pipe 25 and adhering the exposed part of 31 to the marker itself to end as shown in FIG. 9, with the conserved part of 41 avoiding direct contact between pipe 25 and layer 31.

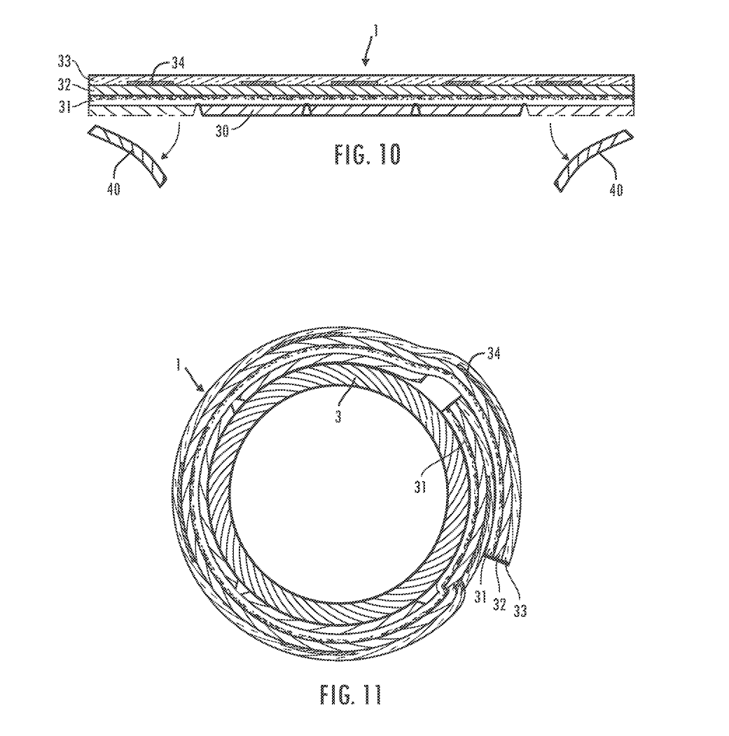

FIG. 10 illustrates the removal of the two outer stripes 40 of release liner 41 using secured installation mode shown in FIG. 5. This method consists of adhering one of the exposed stripe of 31 to pipe 25, wrapping marker 21 around pipe 25 and finally adhering the opposite exposed part of 31 to the marker itself to end as shown in FIG. 11 with the conserved part of 41 partially avoiding contact between pipe 25 and layer 31 and thus facilitating later removal.

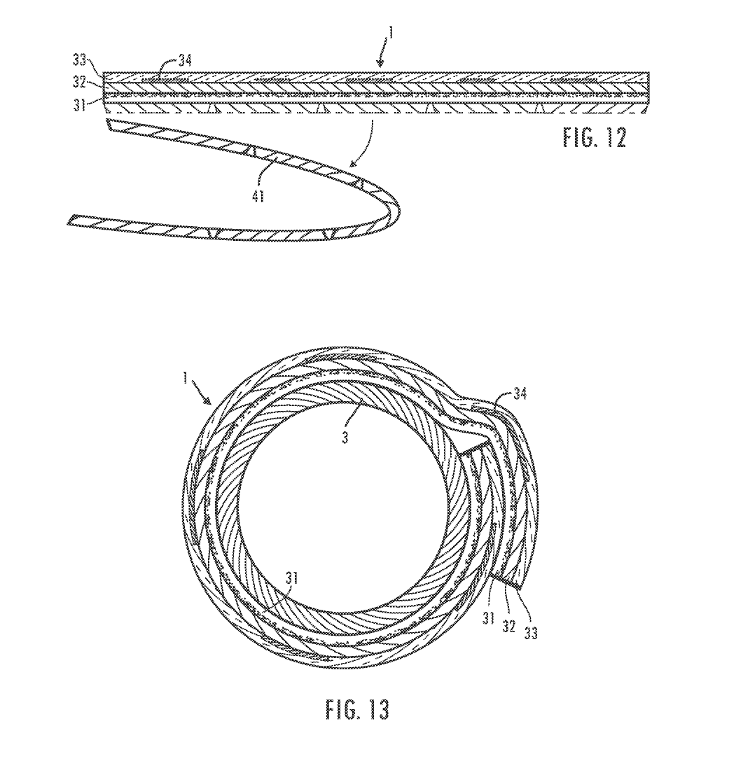

FIG. 12 illustrates the full removal of release liner 41 of marker 21 using method shown in FIG. 6 thus totally exposing layer 31 before adhering marker 21 to pipe 25 full circumference in self-adhesive wrap-around mode to end as shown in FIG. 13.

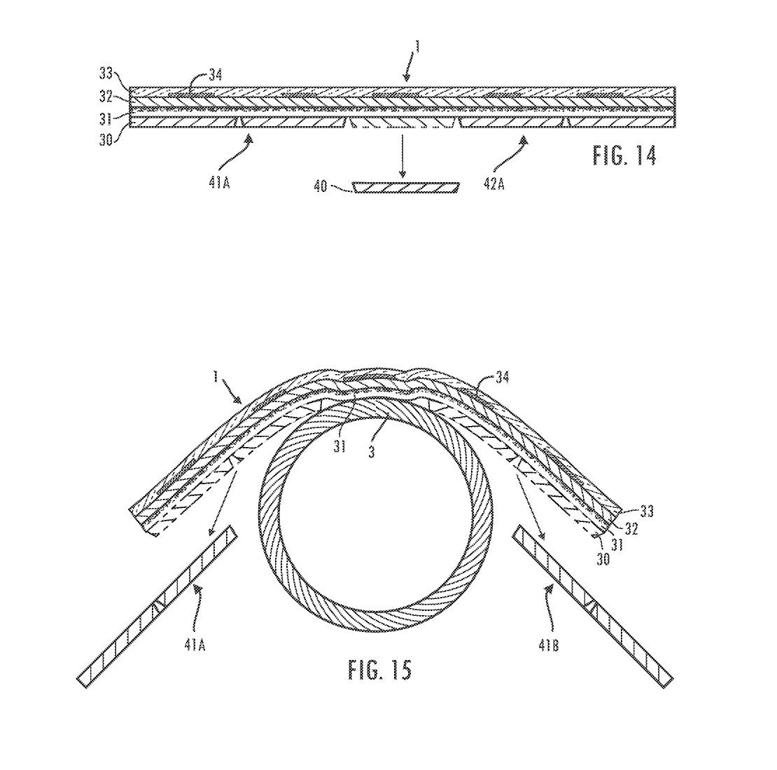

FIG. 14 illustrates the removal of one center stripe using method shown in FIG. 5 as a first step in an assisted variation of the self-adhesive wrap-around mode. Marker 21 is then adhered to pipe 25 using exposed stripe of 31 as shown in FIG. 15. The reduced size of the exposed adhesive compare to the full marker as described previously in self-adhesive wrap-around mode facilitate alignment of the marker to the pipe axis. Subsequently release liner parts 41A is removed, exposed part is secure around half pipe 25, followed by removal of 41B and completion of installation whose end result is similar to the self-adhesive wrap-around mode shown previously in FIG. 13.

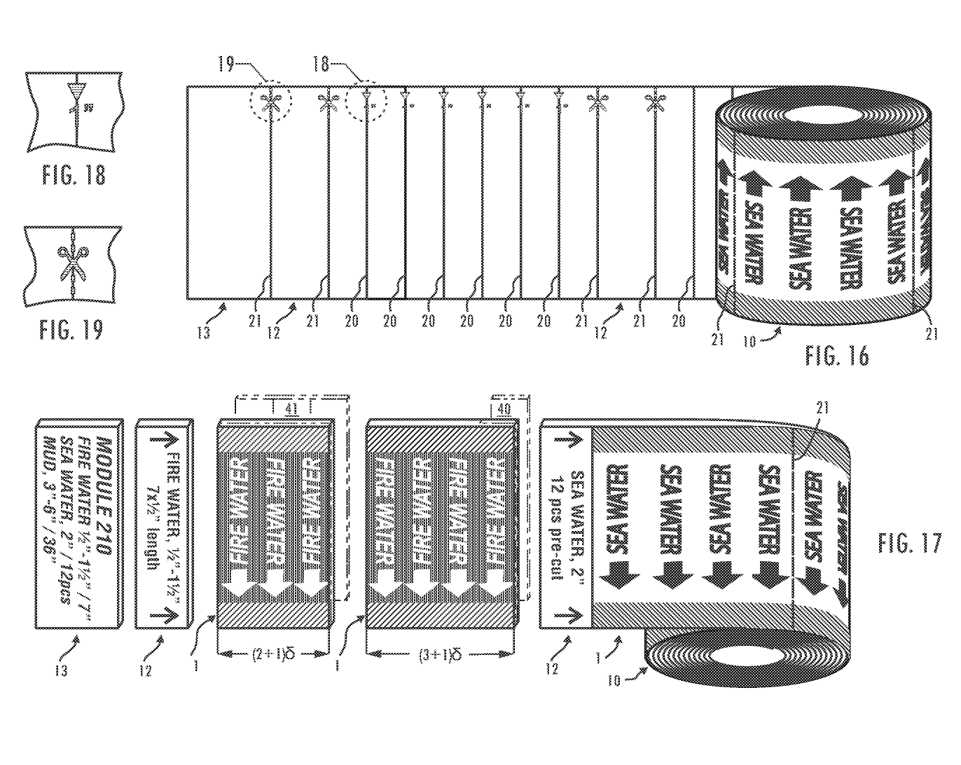

Another preferred embodiment of the present invention includes cut lines 23 as shown in FIG. 16 having as illustrated in FIG. 18 a label 26 printed on release liner at either one or both sides of the tape, such label allowing firstly to easily locate said lines 23 and secondly said labels 26 including the pipe diameter increment equivalent to the distance between two said lines 23 to easily count and select said lines 23 required to obtain a wrap-around pipe marker matching targeted pipe diameter.

Another preferred embodiment of the present invention shown in FIG. 16 is when the exact quantity of each pipe marker dimension is known in advance, the cut lines 24 that separate each marker, and only those lines, are perforated through all the tape layers to allow the manual separation of each individual marker without requiring cutting tools, and said lines 24 have a label 27 illustrated in FIG. 19 printed on release liner at either one or both sides of the tape and said label clearly indicating such line is for easy separation of the pipe marker from the tape.

Another preferred embodiment of the present invention shown in FIGS. 16 and 17 is, when said tape 20 contains series of different pipe marker indicia, any of these series is preceded by a header 28 with the description of the serie's characteristics, such as length and targeted system, printed on the front layer, and optionally with a summary 29 of the full roll content printed at the beginning of the roll itself, this summary and headers being advantageously delineated by lines 24, labelled as shown in FIG. 19, perforated through all the tape layers for easier separation.

What is claimed is:

1. A pipe marker tape for marking a predetermined set of pipes having at least two different outside circumferences comprising:
a front layer for supporting a marker indicia,
an adhesive layer formed on the back of said front layer,
a release liner, deployed against said adhesive layer, having cut lines across the pipe marker tape width at a regular distance δ such that:
individual wrap-around pipe markers are obtained by cutting the front layer and the adhesive layer along selected cut lines while leaving at least two cut lines inside the surface of the individual wrap-around marker, said cut lines left on the obtained markers defining at least three release liner stripes; wherein
for each pipe of the predetermined set of pipes, there is a positive whole number K such that (K+1)× δ is equal to or greater than the sum of the outside circumference of said pipe and a predetermined overlap, so that an individual wrap-around marker fitting installation on said pipe is obtained by cutting said pipe marker tape along two cut lines separated by K+1 release liner stripes.

2. A pipe marker tape according to claim 1, wherein the predetermined set of pipes have outside circumferences that can all be approximated to integer multiples of at least one length, said distance δ being one of said at least one length.

3. A pipe marker tape according to claim 2, wherein said distance S is the greater of said at least one length.

4. A pipe marker tape according to any one of claims 1 to 3, wherein said cut lines consist of discontinuous cuts of length and spacing such that it is easy, on obtained pipe markers, to either remove
a selected individual release liner stripe,
a serie of contiguous release liner stripes or
the full release liner layer
by adjusting the removal effort direction, thus greatly expediting the installation.

5. A pipe marker tape according to any one of claims 1 to 4, that comprises an additional transparent protective layer deployed on top of the front layer.

6. A pipe marker tape according to claim 5, wherein release liner, front layer and protective layer are polyester films and have a typical thickness ranging from 10 μm to 100 μm.

7. A pipe marker tape according to any one of claims 1 to 6, wherein said cut lines are labelled with text and or symbols indicating their position and spacing so as to facilitate their selection to obtain wrap-around pipe markers fitting the outside circumferences of the predetermined set of pipes.

8. A pipe marker tape according to any one of claims 1 to 7, wherein each single pipe marker indicia imprinted on the front layer is centered on a corresponding release liner stripe so as to enable obtaining singular pipe markers when cutting said marker tape on two adjacent cut lines and half-wrap pipe markers when cutting said marker tape on two cut lines chosen to match half of the outside circumference of one pipe of the predetermined set of pipes.

9. A pipe marker tape according to any one of claims 1 to 8, wherein the cut lines delineating predefined set of obtainable pipe markers are discontinuously extending across all the pipe marker tape layers so as to allow easy separation of said pipe markers without the need of a cutting instrument.

10. A pipe marker tape according to any one of claims 1 to 9, that comprises series of different pipe marker indicia, where each such serie is preceded by an imprint on the front layer containing text and/or graphics summarizing the said serie indicia, length, targeted pipe system and other relevant information, said imprint being delineated by perforated lines extending across all the pipe marker tape layers so as to allow easy separation of said imprint without the need of a cutting instrument.

11. A pipe marker tape according to claim 10, that starts with an imprint of a tape table of content containing text and/or graphics abridging pipe marker series contained in the said tape, said imprint being delineated by perforated lines extending across all the pipe marker tape layers so as to allow easy separation of said imprint without the need of a cutting instrument.

12. A method of cutting lines on a pipe marker tape for marking a predetermined set of pipes having at least two different outside circumferences, the tape comprising:
a front layer for supporting a marker indicia,
an adhesive layer formed on the back of said front layer, and
a release liner, deployed against said adhesive layer; said method including
i) defining a distance δ, wherein for each pipe of the predetermined set of pipes, there is a positive whole number K such that (K+1)× δ is equal to or greater than the sum of the outside circumference of said pipe and a predetermined overlap, so that an individual wrap-around marker fitting installation on said pipe is obtained by cutting said pipe marker tape along two cut lines separated by K+1 release liner stripes, and
ii) cutting lines across the pipe marker tape width at the regular distance δ so that individual wrap-around pipe markers are obtained by cutting the front layer and the adhesive layer along selected cut lines while leaving K−1 cut lines inside the surface of the individual wrap-around marker, said K−1 cut lines left on the obtained markers defining K release liner stripes.

13. A method according to claim 12, wherein the predetermined set of pipes have outside circumferences that can all be approximated to integer multiples of at least one length, the step of defining distance δ defines distance δ as being one of said at least one length.

14. A method according to claim 13, wherein the step of determining distance δ defines distance δ as the greater of said at least one length.

15. A method according to claim 13, wherein the steps of determining distance δ define distance δ that minimize the sum of the differences, for each pipe of the predetermined set of pipes said pipe being associated with a whole number K:
(K+1)× δ and
the sum of outside circumference of said pipe and the predetermined overlap.

16. A method according to claim 12, wherein the steps of determining distance δ define distance δ that minimizes the weighted sum of:
the sum for each pipe of the predetermined set of pipes said pipe being associated with a whole number K of the differences of:
(K+1)× δ and
the sum of outside circumference of said pipe and the predetermined overlap
the sum of said K.
